(19) United States
(12) Patent Application Publication
(10) Pub. No.: US 2006/0209630 A1
(43) Pub. Date: Sep. 21, 2006

(54) Mixer for infant formula powder and other infant feeding products

(76) Inventors: Craig E. Brown, Mt. Zion, IL (US); Robert J. Brown, Chesterfield, MO (US)

Correspondence Address: Paul M. Denk;Suite 170, 763 South New Ballas, St. Louis, MO, 63141, US

(21) Appl. No.: 11/370,578

(22) Filed: Mar. 8, 2006

Related U.S. Application Data
(60) Provisional application No. 60/662,097, filed on Mar. 15, 2005.

(51) Int. Cl. B01F 13/00; B01F 3/12; B01F 11/00

(52) U.S. Cl. 366/342; 366/333

(57) ABSTRACT

An infant formula mixer with a stem, with a region either proximal or distally which expands into a mixing membrane. The mixing cup like flexible and resilient membrane is applied at the bottom of its stem, and can be either pressure fitted, snap applied, or integrally molded, or even threadedly engaged, with the membrane, in its formation. Such a membrane may be made of any polymer, acrylic, flexible rubber, or silicone. In typical usage of the mixer, it is applied in an up and down motion, at the distal aspect of the vessel, for such time as the clumps of formula are fractured and dissolved, and inherently mixed within the liquid within the container or bottle, in preparation for usage.

### CROSS REFERENCE TO RELATED APPLICATION

This nonprovisional patent application claims priority to the provisional patent application having Ser. No. 60/662,097, which was filed on Mar. 15, 2005.

### BACKGROUND OF THE INVENTION

This invention relates to means for facilitating the complete mixing of formula powder and related granular feeding products into a liquid for infant consumption.

It is well known that it is necessary for infants to consume liquid nutrition and hydration due to the lack of teeth in early life, particularly during the initial or first year of infancy. Caregivers have the option of breastfeeding, providing other liquids, or using a combination of these methods for feeding. It is necessary to use liquid other than breast-milk for several reasons. Initially, the milk let-down reflex does not occur completely in some women as they begin to breastfeed. Infants sometime need more liquids and nutrition than their mother is able to provide, and supplementation using other liquids with formula is necessary. This particular situation is frequently seen with dehydration, pre-maturity, and the use of bilirubin lights for jaundice. It is also necessary due to the mother and infant being in different locations.

Infant sucking abnormalities are frequently encountered. Premature infants frequently cannot suck forcefully enough to withdraw the adequate amount of breast-milk. In addition, infants with neurological defects frequently cannot suck vigorously enough in order to extract enough liquid for feeding. These infants normally include those with cerebral palsy, downs syndrome, and other neurological conditions.

Infants with structural abnormalities of the mouth, nose, trachea, esophagus, and stomach cannot create enough vacuum to breastfeed adequately. Constitutional abnormalities of the above structures include cleft lips, cleft palates, narrowing of the esophagus, and swallowing abnormalities.

Infant feeding formulas have been available since the 1860's. They are available as a pre-mixed liquid, or a concentrated liquid in powder form. The powder form requires less processing during manufacturing, and is universally more economical to purchase. Due to the heat treatment of powdered formula, the physiochemical properties of the proteins are changed, making them less soluble.

Multiple methods have been proposed to mix the different ingredients needed to make a bottle of infant formula. Whether pre-mixed formula, concentrated liquid that must be mixed with water, or powder is used, the different ingredients of the mixture must be mixed thoroughly and combined together prior to consumption.

With pre-mixed infant formula containers, settling of the incompletely mixed portions to the bottom of the container will result in uneven ingestion of the liquid contents. A similar consequence is noted if liquid concentrate is not thoroughly combined with water, and promptly used.

Formula is also provided in powder form. This is a very commonly used form of infant nutrition, as the shelf life is very long, and it is very economical to utilize. If the powder form is not completely mixed, clumping of its contents Within the feeding nipple and the bottle will occur. The clumped formula masses migrate to the nipple, and therein impedes any further flow of liquid from the bottle. The infant is unable to feed, becomes frustrated, and must stop the feeding process. The caregiver must then disassemble the feeding vessel and clean the apparatus, which can be difficult at times, especially with feeding nipples containing a small aperture. If this must be done, one is unsure of the amount of powder and liquid that has eventually been given, or whether the proper concentration of these components has been provided. The formula must be mixed again to ensure thorough dissemination of the powder into the liquid.

Clumping can also occur inside the feeding bottle. This will impede the egress of the contents of the bottle and necessitate adding more water to the bottle in order to liquefy the clumps of powdered formula that have occurred. This additional amount of liquid may not be desirous, especially in small and premature infants, in whom the total daily liquid ingestion must be closely monitored and regulated. Inconsistent ingestion of the nourishment will occur in this situation, also.

It is critical to provide the entire amount of powder that was intended to be provided to the infant, as well as the proper amount of liquid, as infant's must maintain an adequate level of nutrition and hydration.

Several methods of ensuring the proper amount of formula, and the derived nutrition, as well as thoroughly mixing these components have been investigated. These include various methods of storing, stirring, and shaking the contents of the bottle.

A mixer to eliminate clumping was proposed in U.S. Pat. No. 6,332,407, to Gasser. This device demonstrates a mixer which is shaken along its longitudinal axis in order to mix its contents. A plurality of holes across the interior of the container is incorporated in order to foam the contents. This is certainly an undesirable feature for an infant, within its feeding container, and can easily contribute to the production of colic. See generally, Karofsky, P S, Infantile Colic, Journal of Family Practice, July 1984, 19(1):107-8, 111-2, 114 passim.

The United States patent to Caola, U.S. Pat. No. 5,794,802, the patent to Kaesemayer, U.S. Pat. No. 5,419,445, and the patent to Schwartz, U.S. Pat. No. 4,003,555, show separate containers for the ingredients of the bottle, which can then be mixed by shaking the vessel's contents. This embodiment also demonstrates the same disadvantage of mixing air into the liquid, as previously defined with respect to the Gasser patent. This arrangement results in incomplete mixing of the solid and the liquid contents of the vessel, as well as entrainment of significant amount of air into the liquid, which the child then ingests. This results in irritability and colic.

There are a multitude of patents that have been proposed that demonstrate the application of a series of inserts of various shapes into the middle of the vessel, which are placed in order to aid in mixing of its contents. The patent to Tseng, U.S. Pat. No. 5,788,369, the patent to Ghavi, U.S. Pat. No. 4,818,114, the patent to King, U.S. Pat. No. 4,208,136, the patent to Van Horbek, U.S. Pat. No. 4,065,107, the patent to Swett, U.S. Pat. No. 3,820,692, and the patent to Renz, U.S. Pat. No. 6,616,319, demonstrate various forms of internal materials arranged at different patterns, in the nature of baffles, to help break up the clumps of dry or powdered matter that is being added to the water or other liquid. The clumps of formula are propelled during shaking towards the objects on the interior of the vessel, air is again mixed and entrained into the formula, as can be seen in the above patents, with its coupled increase in air that is ingested and associated irritability, fussiness and colic, which can routinely develop. Again, as in the other patents that are mentioned above, the infant formula is incompletely mixed together with the liquid in the container.

Other patents that show related types of structures, and even for use for other purposes, can be seen in the patent to Dalrymple, No. 563,139, which shows an egg beater. It is a hollow type of structure, made of metal, having various cylinders, bands and hoops provided therein, and for use for helping to beat eggs, deposited within its container.

The patent to Baker, No. 901,313, shows an apparatus for washing clothes. Apparently this is an old device that simply is added into a bucket where clothes are being soaked in soapy water, and then this device is moved both up and down, in an effort to try to help wash the clothes during cleaning.

The patent to Schramm, U.S. Pat. No. 1,523,085, shows another type of egg beater. This device includes a perforated series of disks, which are intended to allow as much air as possible to enter the egg or cream supply, within the cylinder, in order to assist in mixing.

The patent to Dahnke, U.S. Pat. No. 2,486,126, shows what is defined as a mixer. This device includes a disk for agitating, with a series of holes as provided therein, so apparently this device can be moved up and down within the vessel in order to mix in powder contained therein.

The patent to Ghidini, No. RE37,137, shows a milk jug with a froth-forming device for making “Cappuccino” and the like.

The patent to Hess, U.S. Pat. No. 5,695,282, shows a mixing pitcher. This device includes a mixer, which has an impeller at the bottom of its plunger rod, which apparently can be turned, or moved up and down, to achieve a mixing motion.

The patent to Brady, U.S. Pat. No. 5,780,087, shows an apparatus and method for frothing liquids. Once again, this is a device to obtain aeration or frothing of a liquid, and not simply to provide for mixing of a formula therein, which involves a minimal amount of aeration or agitation, so as to reduce the incidence of aeration of the liquid.

Finally, the patent to Gartz, No. U.S. Pat. No. 6,200,015, shows another mixing container.

All of the mixers used for feeding products heretofore known suffer from a number of disadvantages:

(a) They incompletely mix the powder into the infant feeding liquid. They depend upon interiorly placed plates with holes or interiorly placed materials of various shapes to break up the multiple congealed solid masses in the feeding container as the container is agitated in a repetitive fashion. Due to the viscosity of the feeding liquid and the random nature of the movement of the masses in the feeding container, very minimal breakup of the solid masses occur.

(b) Due to the necessary processing of heating of the powder during the manufacturing process, the congealed masses that form during attempted mixing of the powder and a liquid are very firm, slick, mobile, and difficult to break up and dissolve into the liquid. Because of these properties of the masses in the container, minimal mixing of the powder and liquid occurs. The firm masses remain in the liquid during the feeding process. This is very undesirable and harmful to the infant.

(c) Air is introduced into the feeding solution. Air is known to be a contributing factor to colic. The amount of air introduced is proportional to the degree of agitation of the feeding liquid and the length of time that the mixing process occurs. Since the powder is not easily folded into the liquid, a significant amount of air inside the feeding container becomes entrained in the feeding liquid.

(d) A further disadvantage is that all of the above devices intrinsically remain interior to the outside surface of the bottle, and are large, and simultaneously present a very large surface area to the feeding liquid during the mixing and feeding process. Several of the devices have apertures and/or small slits present in their designs also. The large surface area and small apertures magnify the difficulty and time necessary in order to clean the items. Should the items not be thoroughly cleaned, they will retain feeding liquid and congealed particles on their surface, and grow multiple organisms which could potentially harm the infant. These disadvantages are multiplied as the length of the mixing process increases.

### SUMMARY OF THE INVENTION

The mixer of the present invention provides a way of easily, completely, hygienically, and physiologically mixing of infant formula powder, as well as other non-liquids that infants consume.

As is known, when one puts powdered formula into a nursing bottle, and adds some water, and then shakes the bottle, two things occur. One, not all the powder is dissolved, and some of the powder becomes rather lumpy and difficult to dissolve, and furthermore, through shaking, one is adding a substantial amount of air, aeration, and bubbles to the formula, which is undesirable to the infant, when the formula is drank by the infant.

The current invention contemplates a small device that is inserted toward bottom end into the nursing bottle, and it is raised up and down in the bottle, repetitively, in order to help dissolve the powdered clumps and aggregate gel formation of formula, that have not completely mixed into the liquid during preparation. By not raising the membrane above the surface of the liquid, additional air is not entrained into the liquid, which is a highly desirable feature. The device is a cup type of means that can fit through the neck of the nursing bottle with ease, and is permanently mounted to a stem, with a handle at the upper end long enough to extend from the bottom of the container and be held easily by the user. The suction cup, or something shaped like it, may take up approximately two-thirds (⅔) of the interior width of the bottom of a bottle. Then, by simply rapidly raising and lowering of its stem, by way of its handle, at its upper end, the suction cup is compressed up and down at the bottom of a bottle, and all of the formula that was originally clumped together dissolves immediately.

Once the device is used for this particular purpose, it can be removed from the bottle and either easily washed off for re-usage, or merely disposed of.

In order to prevent the suction type cup from adhering to the bottom of the bottle, there may be small vents provided through the cup shaped member, either by way of small hole(s) provided through the upper end of the cup shape, or perhaps a small hole along the stem where the suction cup attaches to it such that the hole enters the suction cup also, or the stem may be hollow, and extend all the way up to the top, to allow for venting of air from the suction cup to the top of the stem One or more small concave or V-shaped cutouts, at the edges of the suction cup, will prevent the suction cup from developing any adherence and attraction to the bottom of a bottle, which would make it difficult for its removal. Hence, by putting various vents, of some structure, within the lower suction cup like member, suction formation is prevented, which makes it easier to handle and use the device. Once the preparation of the formula is started, repeated raising and lowering of the mixer instrument, ten or twenty times, more or less, around the bottom of the bottle, has been found to achieve the goal that all of the powdered formula dissolves, instantly, and does not generate any aeration in the liquid, or cause any other problems within the bottle.

During usage, the preparer simply adds water or other liquid to the baby bottle and the powdered formula is then added to the liquid in the bottle. Alternately, the powder may be added first and the liquid second. After a few seconds, some of the formula dissolves, and a large amount of it clumps up and settles to the bottom of the bottle. Then, one inserts the dissolver or mixer of this invention into the bottle, and taps it up and down while not raising the cup above the superior level of the liquid, upon the bottom of the bottle for approximately ten seconds. By not raising the cup above the superior level of the liquid, air is not introduced into the liquid, which is a very desirable feature. It has been found that all of the powdered formula dissolves when processed in this manner. Then, the preparer simply removes the mixer from the bottle, rinses it under hot water, or can place it even into a dishwasher, for cleaning and re-usage. On the other hand, if the mixer has been designed as a disposable type, it can be simply discarded. The mixing device allows the user, for the first time, to conveniently add powder to the empty bottle for easy transport, eliminating the inconvenience of carrying a separate container of feeding powder. Also, the written directions of the powdered formula manufacturers may be followed, in order, conveniently, for the first time. These state to add water first and then add powder to the liquid. Using this device allows the user, for the first time, to have a fully mixed, homogeneous mixture following the above directions.

It is, therefore, the principal object of this invention to provide a mixing device that could be used for facilitating the complete dissolution of powder or other formula within a liquid in a nursing bottle during its preparation.

Still another object of this invention is to provide a mixing device which thoroughly mixes the infant feeding powder, as well as other infant feeding products that must be presented in a uniform consistency for feeding to the infant or child.

Still another object of this invention is to provide a mixing device, which when used, minimizes the introduction of any air into the feeding mixture.

Still another object of this invention is to provide a mixing device that has no apertures or cavities within it, to clean, except for any small, easily cleanable hole that may be provided through the lower mixing cap, or an aperture through the lower mixer cup and stem handle.

Still another object of this invention is to provide a mixing device that could be easily used repetitively for mixing formula while keeping the cup like membrane below the surface of the liquid at all times, except upon removal after thorough mixing has been achieved.

Yet another object is to provide a mixing device which is easy to manufacture.

Still another object of this invention is to provide a mixing device that is economically manufactured.

Another object of this invention is to provide a mixing device that is not easily broken during its repeat usage.

Yet another object of this invention is to provide a mixing device which is not easily broken during handling.

Still another object of this invention is to provide a mixing device that cannot be injurious to the individual cleaning it.

Another object of this invention is to provide a mixing device that is not injurious to the individual handling it.

Yet another object of this invention is to supply a mixing device that can be used in any number of infant bottles or containers.

These and other objects and advantages for a mixing device which has a minimal amount of concavities, apertures, and surface areas, so as to lessen the surface area and difficulty of cleaning of the infant feeding apparatus after usage. As known, inadequate cleaning can lead towards bacterial colonization within the bottle, and subsequently within the feeding liquid that is delivered to the infant. The introduction of contaminated infant feeding solution can be injurious to the infant.

These and other objects may become more apparent to those skilled in the art upon review of the summary of the invention as provided herein, and upon undertaking a study of the description of its preferred embodiment in view of the drawings.

### BRIEF DESCRIPTION OF THE DRAWINGS

In referring to the drawings, FIG. 1 shows the infant powder mixer of this invention, having a cup shaped resilient lower end, with an upstanding stem, for use as a handle;

FIG. 2 is a top plan view thereof;

FIG. 3 is a front view thereof;

FIG. 4 is a method of connection of the stem to the lower cup shaped membrane of the mixer of this invention;

FIG. 5 shows another method for attaching the stem to the cup shaped membrane;

FIG. 6 discloses clumped formulation of powder that has submerged to the bottom of the infant bottle, that needs to be dissolved; and

FIG. 7 shows usage of the mixture of this invention that is being pushed downwardly against the bottom of the container, to achieve a break-up and mixing of its undissolved powder into the container liquid, to achieve thorough dissolution of the formula.

### DESCRIPTION OF THE PREFERRED EMBODIMENT

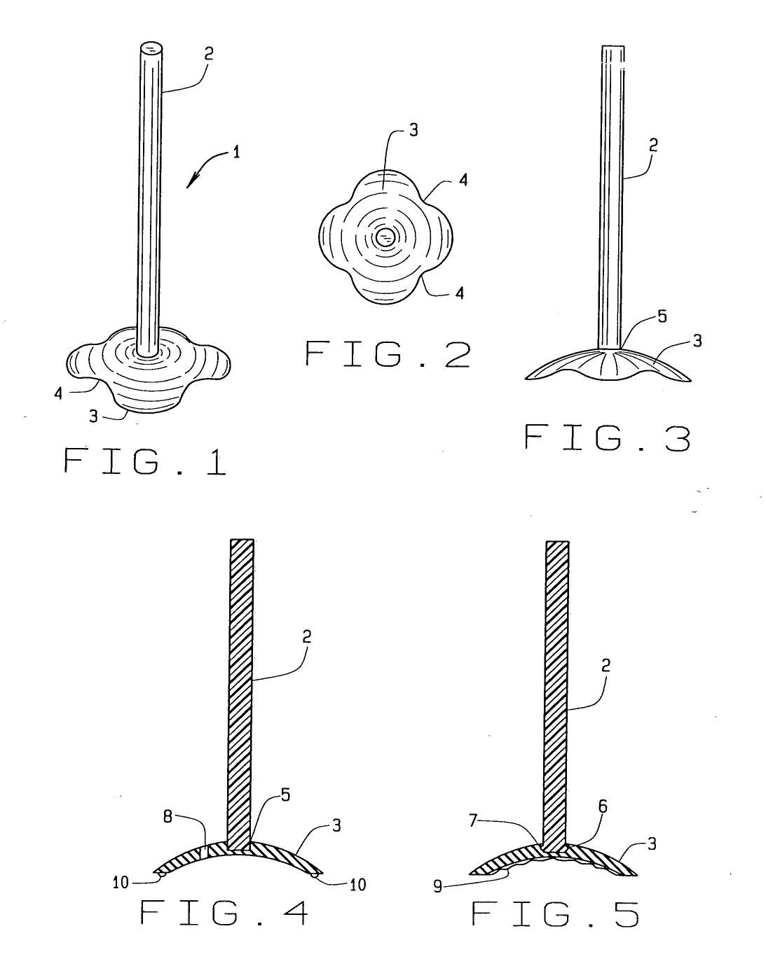

In referring to the drawings, and in particular FIG. 1, therein is shown the mixer 1 of this invention. It includes a stem element 2 with a cup like membrane 3 at its bottom. The cup like membrane is formed of a resilient rubber, polymer, silicone, acrylic, or the like, that has sufficient flexibility, so that when the mixer is moved up and down proximate to the bottom of the bottle in which it is inserted, it will have a tendency to dissolve the lumps of formula located thereat, and cause the powder to break up and instantaneously dissolve, within the formula fluid. In many instances, this fluid will be water, fruit juice, or the like. Flexible cup-like membrane 3 may have one or more concavities or a “V” notches, as at 4, integrated around the outer perimeter of the membrane 3, so as to allow fluid to enter therein, and prevent the development of any suction. This is necessary due to the nature of a suction cup adhering to the bottom of a bottle and preventing its removal, necessitating significant manipulation of the device, or even disposal of fluid, to attain access to the membrane to break its vacuum. Hence, these concavities, as shown at 4, as seen in FIG. 2, may be arranged around the perimeter of the cup shaped membrane 3, or there may be a single such cavity, to allow entrance of fluid under the cupped membrane during its manipulation. As can be further noted in FIG. 3, the stem 2 rises up from the upper midpoint of the membrane 3, and is affixed thereto either by an adhesive, as at the location 5, or other means of connection. For example, FIG. 4 shows how the stem 2 may insert within the upper surface of the cup 3, and either be adhered therein by an adhesive, or other means for connection. It is also possible that the entire stem, with the membrane 3, could be formed integrally, for usage of that manner. In FIG. 5, the lower end of the stem 2 may have an integral bead 6, around its perimeter, and insert within a groove, as at 7, provided within the upper central section of the cup membrane 3, to be affixed therein, for usage.

Many of a variety of methods may be employed to provide for prevention of any vacuum from generating or being developed between the cup 3, and the bottom of a bottle. For example, there may be a single hole provided through the cup, generally as shown at 8, and this may provide for prevention of any vacuum from developing against the bottom of the bottle, during its usage. Or, the bottom of the cup membrane 3 may have a matted, ribbed, curled, channeled, uneven, or other form of roughened bottom, as noted at 9, integrally formed therein, and which will prevent the development of any vacuum, thereunder, as the mixer is reciprocated up and down, within the bottle, and forced against the bottom, in order to break up the powdered formula, and to cause its immediate dissolving.

While the cup shaped membrane 3 of this invention is generally shown as just that, having an arcuate configuration, that is concaved, downwardly; it is just as possible that the membrane may be flat, and simply moved up and down, against the bottom of the bottle, in order to break up any clumps of dry formula, ensuring intermixing of the liquid or fluid that is inserted into the infant feeding bottle.

Obviously, other materials than those identified could be used for manufacturing of the mixer. It may be a flattened segment of metal, metal having a slight concavity, or the membrane may be formed of a partially flexible material, such as a silicone. The mixer membrane may consist of any other material that can be repeatedly minimally flexed without fracturing, such as vinyl, nylon, or various other plasticized materials. The diameter of the membrane is typically three to four centimeters (3 to 4 cm.) in diameter, but may be to almost any size, so long as it is small enough to be introduced into the upper opening of the feeding vessel, but yet large enough to adequately span a significant portion of the bottom of the interior of the bottle, and compress against any solid material formed within the bottle, in order to obtain its break up and dissolution. The thickness of the membrane may be typically in the range of two to three millimeters (2 to 3 mm.), more or less. Any thickness will work, so long as the membrane is rigid enough to easily compress the solid or powder feeding material, and flexible enough not to tear. It should have enough memory to resume its original shape, as it's reciprocated up and down.

The non-stick periphery of the membrane is preferably indented, circumferentially, in order to minimize the possibility of the entire perimeter of the membrane adhering simultaneously to the bottom of the infant feeding bottle, as due to a vacuum formation, as previously reviewed. Such indentations, or alternatively protrusions, which may be slight beads, as shown at 10, may be provided circumferentially around the bottom edge of the perimeter of the membrane 3. These indentations or beads are spaced so as to prevent the adherence and development of any vacuum under the cup shaped membrane, during its usage.

The direct merger of the powder and the mixing liquid, as well as the dissolution of the gel that forms with virtually all types of mixing that involves powder or solid material, is achieved through the bottom surface or contact point of the mixer, as it approaches the region of the bottom of the bottle, during its reciprocation, up and down, during usage.

The region joining the stem and the mixing cup membrane, as at 5, preferably shows an insert that connects the bottom of the stem to the upper central surface of the membrane. These two may be molded integrally or the stem may be pressed on, snapped on, as shown in FIG. 5, or pinned or threadedly engaged, or joined in some fashion.

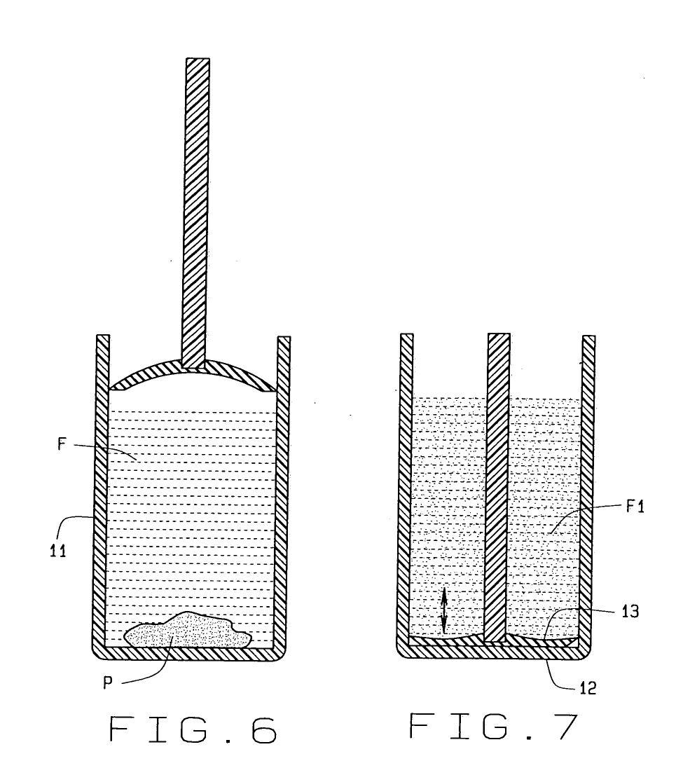

The majority of mixing of newborn and younger infant nutritional products, such as a liquid formula, occurs in the feeding bottle, and although it may occur in other vessels or on a variety of surfaces, usually when the liquid is added to the ingredients, they congeal, enter into the bottom of the bottle, and normally will not dissolve, unless broken up. Such can be seen in FIG. 6, where the bottle 11, at least the lower portion of the bottle as shown, is disclosed as having its fluids F provided therein, and the powdered formula mix, as at P, forms a congealed mass at the bottom of the liquid, and needs to be dissolved. Hence, as can be seen in FIG. 7, as the mixer or plunger is elevated and lowered, repeatedly, for some necessary distance, it will press against the bottom of the bottle, as noted at 12, the cup shaped membrane becomes deformed, as noted at 13, and therein can cause a break up of the powdered formula or clumps, and cause their dissolution into the liquid, to provide for a mixed formulation. As can be seen, the powder is intermixed within the liquid, as noted at F1. The up and down movement of the mixer within the bottle with the cup of the mixer in constant contact with the liquid causes the powder to dissolve and intermix throughout the contained liquid, which readily prepares the formula for immediate warming and consumption.

Regardless of what structure is used for the mixer, whether it be the scalloped configuration as shown in FIG. 2, the aperture 8 provided through the cup shape membrane, or the peripheral beads provided around the edge, as noted at 10, or even the knurled, channeled, uneven, or roughened undersurface, as at 9, all of these are intended to prevent the development of any vacuum, at the bottom of the membrane, as it is pressed against the powdered formula, at the bottom of the bottle, causing break up, and dissolution of the powder clumps into the liquid. In addition to these very useful and desirable features of a mixer of this type, additionally it attains mixing of the formula, with a minimal amount of aeration within the bottle, and its formed liquid formula, which prevents the transfer of any air bubbles to the infant, during feeding. This is a desirable feature of this invention, as previously summarized.

Thus, it is important to obtain these results in order to minimize the amount of air that the infant consumes, as air ingestion is associated with infant conditions such as colic, fussiness, and abdominal distention.

As previously reviewed, if a mixing member adheres onto the bottom of the feeding container, as a result of the formation of a significant amount of vacuum under the membrane itself, it is exceedingly difficult to move the membrane and its attendant stem off the bottom of the feeding container, and use it repeatedly, in order to achieve dry formula dissolution, and its intermixing within the fluid within the bottle. If a complete vacuum forms under the mixing membrane, of the mixer, it is necessary to pour out the contents of the feeding vessel and use another solid object as a knife or probe in attempting to remove the membrane from the bottom of the container. This not only leads to a loss of formula capacity and mixing at the desired amount previously determined to be a proper serving for the infant, but secondly, it can lead toward contamination of the formula. If attempts are made to loosen the membrane with some other instrument, this can also lead toward contamination.

In the above description of the preferred embodiment, there are a number of advantages to the mixer of this invention, which should become evident. For example, a mixer can be economically produced, occupy a very small space in a bag or other carrying case, and be child safe. The mixer completely mixes the feeding powder with the mixing liquid. Furthermore, it efficiently compresses the inherent aggregate-type gel and causes complete mixing of the gel clumps, formed of the powder, into the liquid component of the feeding liquid. This ensures proper proportions and amounts of the feeding liquid. As there is complete mixing of the powder into the liquid, there in no plugging of the nipple aperture, at the top of the bottle, nor is there any need to disassemble the feeding vessel in order to attempt to remove the aggregate powdered gel. There is no potentially harmful dilution, via formation of a hypotonic solution, of the feeding liquid while attempting to mix the gel aggregate. Furthermore, the periphery of the mixing membrane, as well as the other methods of nonadherence ensures that a vacuum formation will not form under the interior or out at the peripheral edge surfaces of the membrane. This enables the membrane to attach to the stem of the mixer and to be removed from the interior aspects of the feeding vessel, during its application, and upon final removal. As there is complete mixing of the powdered gel into the liquid, there is no need to agitate the liquid or stir the liquid vigorously, as shaking and stirring introduce air into the liquid and increase infant medical problems including complications of gas, colic, reflux, and irritability.

Accordingly, one can see that the mixer of this invention can be easily and economically produced, provide a simple and efficient method of mixing the components of infant feeding liquid and may be easily used. Furthermore, it provides a method of completely mixing the ingredients, which has not been available until the present invention. In addition, it obviates the powdered gel aggregate formation and its attendant mechanical difficulties. These difficulties include plugging of the aperture and the need to disassemble the feeding container in order to clean the nipple aperture itself. The infant will find it difficult or impossible to feed if the aperture of the feeding nipple is obstructed. This problem is magnified exponentially if the infant has any feeding difficulties, such as those that occur with pre-maturity, cerebral palsy, cleft lip and palate, hypotonia and many other conditions that cause the inability to generate the minimal necessary negative pressure in the oral cavity in order to remove the feeding liquid from the feeding container.

The powdered gel formation also necessitates opening of the bottle to attain its fragmentation, or adding water to the liquid, thus making it hypotonic and at suboptimal concentration of the infant. This is particularly critical in premature infants who require exact nutrients and exact concentrations of those nutrients.

The present invention also provides for a mixing device that will not adhere to the interior aspects of the mixing container and will allow for rapid, efficient and complete mixing of the contents of the bottle. This permits formulation of a homogeneous mixture without the entrainment of air bubbles into the mixture, and its attendant medical difficulties that are generated within the child, as previously reviewed.

Although the description of the invention contains many specifics, these should not be construed as limiting the scope of the present invention. These should be considered as illustrative of some of the presently preferred embodiments of this invention. For example, the mixer can have other sizes and shapes, such as the stem of the mixer being longer or shorter, the mixer can be used within a baby bottle, or a sippy cup type of container, and the mixer membrane can have a larger or smaller diameter, and yet be as effective for pressing against and breaking up any congealed powder, during its usage. The mixer membrane may have different peripheral patterns that insure a non-stick surface on the bottom of the membrane, as it is applied against the bottom of the feeding vessel, during usage.

Variations or modifications to the subject matter of this development may occur to those skilled in the art upon review of the invention as described herein. Such variations, if within the spirit of this development, are intended to be encompassed within the scope of this invention as reviewed. The depiction of the invention, as it is described in the preferred embodiment, and as shown in the drawings, are set forth for illustrative purposes only.

1. A mixer for infant formula powder and other infant feeding products including a mixer having a stem, a lower cup like member affixed to the bottom end of the stem, a cup like membrane having means to prevent formation of any vacuum thereunder, and compressed against the bottom of the container, said liquid added to the ingredients contained within the container and which can be fractured, dissolved and intermixed within the liquid in preparation for its delivery to an infant.

2. The mixer of claim 1 wherein the cup like membrane has a fluted edge, to facilitate its movement up and down within a nursing bottle to achieve mixing of the infant formula.

3. The mixer of claim 1 wherein the cup like membrane has at least one aperture therein to prevent suction from adhering the membrane to the bottom of any nursing bottle during the mixing of any infant formula.

4. The mixer of claim 2 wherein the fluted edge of the cup like membrane allows the fluid to bypass said membrane during its up and down movement within any nursing bottle to attain mixing of the infant formula.

5. The mixer of claim 1 wherein the cup like membrane is fabricated from water resistant polymer, silicone, vinyl, nylon, and rubber.

6. The mixer of claim 1 wherein said lower cup like membrane has a notch provided upon its outer periphery, to prevent the cup like membrane from forming a suction with the bottom of any nursing bottle in which the infant formula is mixed.

7. The mixer of claim 6 wherein in the notch is a V-notch.

8. The mixer of claim 1 wherein a protrusion extending from the approximate lower surface of the cup like membrane and which can encounter the bottom of any nursing bottle in which it is applied in order to prevent the development of any suction of the mixer with the nursing bottle.

9. The mixer of the claim 8 wherein the bottom of the cup like membrane has a roughened texture so as to prevent the generation of any suction with the bottom of any nursing bottle in which the mixer is applied.

10. The mixer of claim 9 wherein the bottom of the cup like membrane is knurled.
